(19) United States
(12) Patent Application Publication
(10) Pub. No.: US 2018/0149408 A1
(43) Pub. Date: May 31, 2018

(54) Home Appliance Device and Method for Assembling a Home Appliance Device

(71) Applicant: BSH-HAUSGERAETE GMBH, Muenchen (DE)

(72) Inventors: SERDAR AKCA, TEKIRDAG (TR); MEHMET CIYANOGLU, ISTANBUL (TR); LARS DINTER, MUENCHEN (DE); EMRE GUENTAV, ISTANBUL (TR); TANZER YILDIZGOECER, TEKIRDAG (TR); RASIT OENVER, TEKIRDAG (TR)

(21) Appl. No.: 15/364,495

(22) Filed: Nov. 30, 2016

(51) Int. Cl. F25D 23/02; F25D 11/00; F25D 23/12; E05B 17/00; E05F 1/00

(52) U.S. Cl. CPC F25D 23/028; F25D 11/00; E05F 1/00; E05B 17/0033; F25D 23/126

(57) ABSTRACT

For the purpose of improving properties regarding construction a home appliance device, in particular a home chiller appliance device, is proposed. The device has at least one main body defining at least one storage space; at least one door mounted to the main body and featuring at least one sealed door section that forms at least a portion of a front wall of the storage space; and at least one protrusion unit arranged next to the sealed door section outside the storage space and protruding from the door towards the main body.

### BACKGROUND OF THE INVENTION

### Field of the Invention

The invention relates to a home appliance device, in particular a home chiller appliance device, and to a method for assembling a home appliance device, in particular a home chiller appliance device.

From the prior art, refrigerators comprising a main body and a door are known. The door features a sealed section which delimits a storage space within an inner liner towards a front side. The door is flat except for the sealed section outside the storage space.

### SUMMARY OF THE INVENTION

An objective of the invention is, in particular, to provide a home appliance device with improved characteristics regarding construction. This objective is achieved, according to the claimed invention. Further implementations and further developments of the invention may be gathered from the dependent claims.

A home appliance device, in particular a home chiller appliance device, is proposed, comprising: at least one main body defining at least one storage space; at least one door mounted to the main body and featuring at least one sealed door section that forms at least a portion of a front wall of the storage space; and at least one protrusion unit which is arranged next to the sealed door section, in particular on an inside of the door, outside the storage space and protrudes in particular significantly from the door towards the main body.

By means of the invention, in particular an advantageous construction of a home appliance device can be achieved. High user-friendliness can be provided. Furthermore, high efficiency and/or low energy demand can be achieved. A durable and/or reliable construction for a door opening assistant can be provided. In particular, component load during transmission of opening forces can be reduced. Furthermore, undesired heat transfer can be minimized. In addition, comfort functions like a supply of ice water and/or ice cubes can be efficiently implemented in a home appliance. In particular, different functionalities can be implemented in a door of a home appliance, in particular in a space-efficient manner. Furthermore, easy and/or cheap assembly is facilitated.

By a “home appliance device” is in particular to be understood at least a portion, in particular a sub-assembly group, of a home appliance. The home appliance is in particular provided for storing and in particular tempering victuals such as beverages, meat, fish, vegetables, fruits, milk and/or dairy products in at least one operating state, in particular for the purpose of enhancing a keepability of the stored victuals. In particular, the home appliance is embodied as a home chiller appliance which is in at least one operating state configured for cooling victuals. The home chiller appliance could in particular be embodied as a climate cabinet, an ice-box, a refrigerator, a freezer, a refrigerator-freezer combination and/or a wine cooler. However, the home appliance could also be embodied as a home appliance for warming and in particular for cooking victuals, e.g. an oven, a steamer and/or a microwave. In this context, “configured” is in particular to mean specifically programmed, designed and/or equipped. By an object being configured for a certain function is in particular to be understood that the object implements and/or fulfills said certain function in at least one application state and/or operating state.

In particular, the home appliance device may comprise at least one inner liner. In particular, the home appliance device may comprise at least one outer liner. In particular, the inner liner may be arranged inside the outer liner. In particular, there may be a gap between the inner liner and the outer liner, which may in particular be filled with foam, for instance with polyurethane foam. During assembly, the inner liner may in particular be placed inside the outer liner and the gap may be subsequently filled with foam during foaming. In particular, the inner liner and the outer liner may together form at least a portion of the main body or the main body of the home appliance device.

In particular, the storage space may be arranged within the inner liner. The storage space may in particular be delimited by the main body and by the sealed door section. In particular, the door may be pivoted about a vertical pivot axis. In this context, “vertical” is in particular to be understood as referring to a direction that is perpendicular to a ground on which the home appliance and/or the home appliance device stands in at least one normal operating condition. In particular, the home appliance device may have at least one height direction. The height direction is in particular oriented vertically. Furthermore, the main body may have in particular at least one top side and/or at least one bottom side. In particular, the height direction may point from the bottom side of the main body to the top side of the main body.

In particular, the sealed door section may have a rectangular shape. In particular, the sealed door section may form the front wall of the storage space. In particular, the sealed door section may feature at least one sealing lip, which in particular, may implement an outer border of the sealed door section. In particular, in a closed state the sealing lip may be in contact with the main body. In particular, the door may be the only door for the storage space. However, it is conceivable that the home appliance device may comprise at least one additional storage space, which may be accessible through the door and/or through an additional door. For instance, the storage space may be implemented as a refrigerator storage space and/or the additional storage space may be implemented as a freezer storage space or vice versa. It is further conceivable that the home appliance device may feature at least one second door for the storage space. For instance, the door and the second door may be implemented in a french-door assembly.

In particular, the protrusion unit may be arranged below the sealed door section. In particular, the protrusion unit may be arranged closer to the bottom side of the main body than the sealed door section, particularly in a direction parallel to the height direction.

In particular, the protrusion unit may be at least partly, in particular solely or completely connected to the door. However, it is also conceivable that the protrusion unit may be at least partly or solely connected to the main body. In particular, the protrusion unit may be in parts connected to the door and in parts connected to the main body. In particular, the door may comprise at least one non-sealed door section arranged next to the sealed door section outside the storage space, in particular arranged below the sealed door section. In particular, the protrusion unit may be connected to the non-sealed door section. In particular, the protrusion unit may be arranged adjacent to the non-sealed door section. In particular, the non-sealed door section may be at least substantially planar or planar. In particular, the protrusion unit may protrude, in particular significantly, from the non-sealed door section towards the main body, for example by at least 1 cm or by at least 2 cm or by at least 5 cm or by at least 7 cm.

Further, it is proposed that the protrusion unit may feature a smaller horizontal extent than a horizontal extent of the sealed door section. In particular, “horizontal” is to be understood with reference to “vertical”. The horizontal extent may in particular an extent that is perpendicular to the height direction and/or parallel to a main extension plane of the door and/or of the non-sealed door section and/or of the sealed door section. In particular, the horizontal extent of the protrusion unit may be no greater than 50% or no greater than 20% or no greater than 10% of the horizontal extent of the sealed door section. In particular, the horizontal extent of the sealed door section may at least be substantially the same or may be the same as a horizontal extent of the door. In particular, a main extension direction of the protrusion unit may be oriented parallel to the height direction. In particular, the protrusion unit may be arranged centrally with respect to the horizontal extent of the sealed door section. A “main extension plane” of an object is, in particular, to be understood as a plane extending parallel to a largest side of an imaginary rectangular cuboid which only just entirely encloses the object and preferably extends through a geometric center of the object. A “main extension direction” of an object is, in particular, to be understood, in this context, as a direction extending in parallel to a largest side of an imaginary rectangular cuboid which only just entirely encloses the object. In this context, the term “at least substantially” is to mean that a deviation of a first value from a second value is in particular smaller than 25%, preferably smaller than 10% and advantageously smaller than 5% of the second value. As a result, advantageous properties regarding an arrangement of components can be achieved.

High comfort and/or high durability can be achieved if the home appliance device may comprise a door opening assisting unit featuring at least one opening element, and if the protrusion unit may feature at least one contact element for the opening element. In particular, the door opening assisting unit may be arranged within the main body. In particular, the door opening assisting unit may be arranged outside the storage space. In particular, the opening element may be rod-shaped. In particular, the opening element may be implemented as a push rod. In particular, the opening element may be configured for being pushed against the contact element in at least one door opening condition. In particular, the door opening assisting unit may be configured for partly opening the door and/or for supporting a user in opening the door. In particular, the door opening assisting unit may be configured for detecting at least one door opening request of a user. In particular, the contact element may be implemented separately from the door. In particular, the contact element may be connected to the door. In particular, the contact element may define a top end of the protrusion unit. In particular, the contact element may be at least partly or at least to a large extent or completely be made of metal. It is also conceivable that the contact element may be at least partly or at least to a large extent or completely be made of plastic. The term “at least to a large extent” is in particular to mean to an extent of at least 55%, preferably to an extent of at least 65%, further preferably to an extent of at least 75%, advantageously to an extent of at least 85% and further advantageously to an extent of at least 95%. In particular, the contact element may be made of one piece. “Made of one piece” is, in particular, to mean, in this context, manufactured from one single piece, e.g., by production from one single cast and/or by manufacturing in a one-component or multi-component injection-molding process, and in particular from a single blank.

For the purpose of efficient and/or targeted force transmission, it is proposed that the contact element may feature at least one contact surface for the opening element, which contact surface may be aligned at least substantially parallel or parallel to a main extension plane of the door and/or of the non-sealed door section and/or of the sealed door section. In particular, the contact surface may be configured for receiving a pushing force exerted onto it by the opening element. The contact surface may in particular be larger than a forward surface, e.g. a forward facing surface, of the opening element, which is in contact with the contact surface in the door opening condition. In particular, the contact surface is rectangular, in particular squared. In particular, the contact element may be box-shaped. In particular, the contact element may feature at least one contact element side wall which may be connected to a contact element front wall, which contact element front wall may feature the contact surface. In particular, the contact element may feature three contact element side walls, which are connected to the contact element front wall, namely in particular a top side wall and two lateral side walls. It is also conceivable that the contact element may feature four or more contact element side walls, in particular including at least one bottom side wall. In particular, the contact element front wall may be rectangular, in particular squared. In particular, the contact element may feature at least one rectangular, in particular squared cross section. In this context, “at least substantially parallel” is in particular to mean an orientation of a direction with respect to a reference direction, in particular in a plane, wherein the direction has a deviation from the reference direction in particular of less than 15°, advantageously of less than 10° and particularly advantageously of less than 2°.

High-level strength and/or easy manufacturability can be achieved if the contact element may be implemented as a bent sheet metal piece. In particular, the contact element may be implemented as a stamped and-bent-piece.

Advantageous properties regarding force transmission can be achieved if the contact element may feature at least one contact element side wall with a step-shaped contour. In particular, the contact element side wall may be connected to the contact element front wall. In particular, the step-shaped contour may be arranged on a top side of the contact element side wall. In particular, the contact element may comprise at least one contact element side wall which may be step-shaped and which may in particular feature at least one front side surface which may be oriented parallel to the contact surface and/or arranged offset from the contact surface towards the door. In particular, the contact element may feature a rear-side cross section which may be significantly larger than the contact surface and which may in particular be arranged on a rear side of the contact element facing the door.

For the purpose of avoiding wear owing to operation of a door opening assistant, it is proposed that the protrusion unit may comprise a fixing unit featuring at least one fixing element, that the contact element may be connected to the fixing element, and that the fixing element may be arranged inside a foamed gap space of the door. In particular, the fixing element may be arranged inside the door. In particular, the contact element may be connected to the fixing element in the height direction. In particular, the contact element may be connected to the fixing element from below the sealed door section. In addition, the fixing unit may comprise at least one support element which the fixing element is connected to. In particular, the support element is plate-shaped. In particular, the support element may be arranged inside the door, for example within the foamed gap space of the door, and/or outside the foamed gap space of the door, in particular on a side of the foamed gap space that faces away from the storage space.

Furthermore, it is proposed that the protrusion unit may feature at least one air separator, which separates two adjacent air spaces, in particular at least one first air space and at least one second air space, which may be located outside the storage space and arranged between the door and the main body. In particular, the contact element and the air separator together implement the protrusion unit.

In particular, the home appliance device may comprise at least one machine compartment arranged next to the non-sealed door section and/or next to the storage space, in particular below the storage space and/or within the main body. In particular, the machine compartment may comprise at least one first sub-compartment arranged behind the first air space and at least one second sub-compartment arranged behind the second air space. In particular, the first sub-compartment and the second sub-compartment may be separated from each other, in particular by at least one divisional wall. In particular, the first sub-compartment may be open towards and/or connected to the first air space and/or the second sub-compartment may be open towards and/or connected to the second air space, particularly through at least one ventilation grille. In particular, the first sub-compartment may comprise at least one fresh-air entrance, which may in particular be connected to the first air space, and/or the second sub-compartment comprises at least one heated-air exit, which may in particular be connected to the second air space. In particular, the first air space and/or the second air space may be delimited by the sealed door section, in particular on a top side. In particular, the first air space and/or the second air space may be open towards an outside, in particular away from the sealed door section, in particular towards the bottom side of the main body and/or towards the ground. In particular, the air separator may, in particular solely, be connected to the door, in particular to the non-sealed door section. In particular, the air separator may be in contact with the door and with the main body, at least in a closed state of the door. In particular, the air separator may be plate-shaped. In particular, a main extension plane of the air separator may be oriented perpendicularly to the main extension plane of the door and/or parallel to the height direction. In particular, a main extension direction of the air separator may be oriented parallel to the height direction. In particular, the air separator may be arranged next to the contact element, in particular below the contact element. In particular, the air separator may be in contact with the contact element. The air separator may in particular be at least partly, in particular at least to a large extent, in particular completely be made of plastic. However, it is also conceivable that the air separator is at least partly, at least to a large extent or completely made of metal. As a result, undesirable heat exchange can be prevented and/or a high grade of efficiency can be achieved.

For the purpose of effective thermal screening it is proposed that the air separator may feature at least one sealing element that may contact the main body, at least in a closed state of the door. In particular, the sealing element may extend from the contact element towards a bottom end of the non-sealed door section. The sealing element may in particular be implemented as an, in particular straight, sealing lip. It is further conceivable that the air separator may feature an additional sealing element that contacts the door, in particular the non-sealed door section. In particular, the sealing element and/or the additional sealing element may at least partly, in particular at least to a large extent and further in particular completely be made of plastic, in particular of an elastomer. In particular, the sealing element may at least partly be macroscopically deformable, or macroscopically deformable. In particular, the air separator may comprise at least one support element. The sealing element and/or the additional sealing element may be in particular connected to the support element. In particular, the support element or at least a portion of the support element, in particular a portion of the support element extending over at least 50%, preferably over at least 75% of a length of the support element, may be plate-shaped. In this context, a “macroscopically deformable object” is, in particular, an object having at least one extension in at least one direction, which extension can be, in particular temporarily and/or without damage, altered by at least 1%, preferably by at least 5%, further preferably by at least 20% and advantageously by at least 50% when a force is applied to the object that is no greater than 100 kN mm⁻², preferably no greater than 10 kN mm⁻² and advantageously no greater than 1 kN mm⁻².

Easy manufacturability can be achieved and/or a diversity of parts can be reduced if the air separator may be connected to the contact element. In particular, the air separator may be fixed to the contact element.

Fast and/or easy alignment during assembly and/or high air-tightness can be achieved if the air separator may partly be inserted in the contact element, in particular from a bottom side of the contact element. The contact element in particular covers a top portion of the air separator. In particular, the air separator may be connected to the contact element by at least one fastening element, in particular by at least two fastening elements, for instance by screws and/or bolts and/or pins and/or nails and/or rivets, in particular from two opposite sides.

For the purpose of providing reliable locking and/or failsafe manufacturability, it is proposed that the contact element may feature at least two mounting holes for the air separator which have different hole axes. In particular, the hole axes may be oriented at least substantially parallel, or parallel, to each other and/or at least substantially parallel, or parallel, to the horizontal direction. The air separator may in particular be fixed to the contact element by at least one fixing element per mounting hole. In particular, the mounting holes may be offset from each other along the height direction. As a result, turning of elements during screwing can be avoided.

It is further proposed that the home appliance device may comprise at least one liquid line, in particular at least one water line, which runs through the protrusion unit, in particular through the contact element and/or through the air separator, in particular in a direction parallel to the height direction. In particular, the liquid line may be part of an ice supply unit and/or an ice water supply unit and/or an ice water dispenser unit, which may be in particular part of the home appliance device and which may in particular be arranged on the door. In particular, the liquid line may be a water supply line. As a result, high comfort can be provided while a structural complexity can be reduced.

Advantageous properties regarding construction can be achieved with a home appliance comprising at least one home appliance device according to the invention.

Furthermore, a method for assembling a home appliance device, in particular a home chiller appliance device, is proposed, wherein the home appliance device comprises: at least one main body defining at least one storage space; at least one door mounted to the main body, featuring at least one sealed door section forming at least a part of a front wall of the storage space; at least one door opening assisting unit having at least one opening element; and at least one protrusion unit arranged next to the sealed door section outside the storage space, which protrudes from the door towards the main body and which features at least one contact element for the opening element and at least one air separator separating two adjacent air spaces which are located outside the storage space and arranged between the door and the main body; and wherein the air separator is attached to the contact element.

By means of the invention, in particular an advantageous construction of a home appliance device can be achieved. High user-friendliness can be provided. Furthermore, high efficiency and/or low energy demand can be achieved. A durable and/or reliable construction for a door opening assistant can be provided. In particular, component load during transmission of opening forces can be reduced. Furthermore, undesired heat transfer can be minimized. In addition, comfort functions like a supply of ice water and/or ice cubes can be efficiently implemented in a home appliance. In particular, different functionalities can be implemented in a door of a home appliance, in particular in a space-efficient manner. Furthermore, easy and/or cheap assembly is facilitated.

Herein the home appliance device and the method according to the invention are not to be limited to the application and implementation described above. In particular, for the purpose of fulfilling a functionality herein described, the home appliance device and the method according to the invention may comprise a number of respective elements, structural components, units and/or steps that differs from the number mentioned herein. Furthermore, regarding the value ranges mentioned in this disclosure, values within the limits mentioned are to be understood to be also disclosed and to be used as applicable.

Further advantages may become apparent from the following description of the drawing. In the drawing exemplary embodiments of the invention are shown. The drawing, the description and the claims contain a plurality of features in combination. The person having ordinary skill in the art will purposefully also consider the features separately and will find further expedient combinations.

If there is more than one specimen of a certain object, in some instance only one of these may be given a reference numeral in the figures and in the description. The description of this specimen may be correspondingly transferred to the other specimens of the object.

### BRIEF DESCRIPTION OF THE SEVERAL VIEWS OF THE DRAWING

FIG. 1 a home appliance comprising a home appliance device, in a perspective view,

FIG. 2 a portion of the home appliance device, including a door and a protrusion unit of the home appliance device, in a perspective view,

FIG. 3 a portion of the home appliance device, including a door opening assisting unit of the home appliance device, in a schematic sectional lateral view,

FIG. 4 a portion of the home appliance device, including a machine compartment of the home appliance device, in a schematic sectional top view,

FIG. 5 a portion of the door of the home appliance device, including the protrusion unit, in a perspective view,

FIG. 6 a contact element of the protrusion unit, in a perspective view,

FIG. 7 the contact element, in a schematic lateral view,

FIG. 8 the contact element, in an additional schematic lateral view,

FIG. 9 the protrusion unit, in a schematic exploded view,

FIG. 10 a schematic flow chart of a method for assembling a home appliance device,

FIG. 11 an alternative home appliance comprising an alternative home appliance device, in a perspective view,

FIG. 12 a protrusion unit of the alternative home appliance device, comprising a contact element and an air separator, in a schematic exploded view,

FIG. 13 a support element of the air separator, in a schematic front view,

FIG. 14 the support element, in a schematic lateral view,

FIG. 15 the contact element and a fixing unit of the alternative home appliance device, in a perspective view,

FIG. 16 a further alternative home appliance device in a perspective view,

FIG. 17 a contact element of a protrusion unit of the further alternative home appliance device, in a perspective view,

FIG. 18 the contact element, in a further perspective view, and

FIG. 19 a portion of the further alternative home appliance device, including the contact element and a liquid line, in a perspective view.

### DETAILED DESCRIPTION OF THE INVENTION

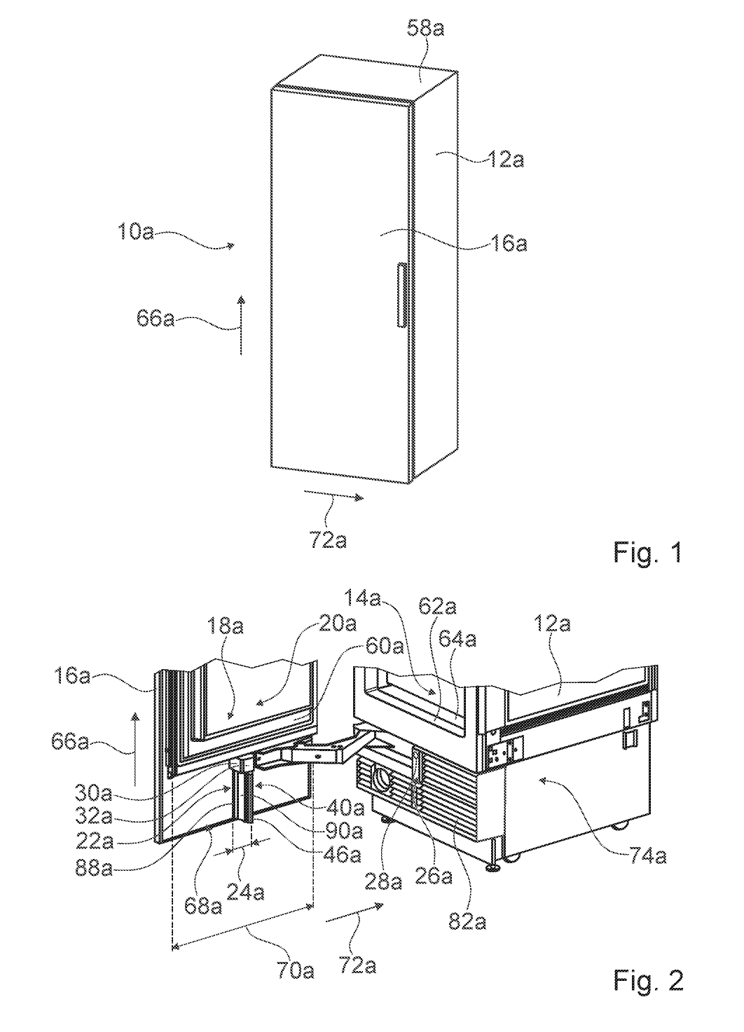

FIG. 1 shows a home appliance 58a in a perspective view. The home appliance 58a comprises a home appliance device 10a. The home appliance 58a is implemented as a home chiller appliance. In the case shown the home appliance 58a is implemented as a refrigerator. The home appliance device 10a is implemented as a home chiller appliance device.

The home appliance device 10a comprises a main body 12a. Furthermore, the home appliance device 10a comprises a door 16a mounted to the main body 12a. The main body 12a has a height direction 66a. The height direction 66a is a vertical direction.

FIG. 2 shows a portion of the home appliance device 10a, including the door 16a and the main body 12a, in a perspective view. The main body 12a defines a storage space 14a. The main body 12a comprises an outer liner 62a and an inner liner 64a, which is arranged within the outer liner 62a.

The door 16a features a sealed door section 18a that forms at least a portion of a front wall 20a of the storage space 14a. The sealed door section 18a comprises a sealing lip 60a, which seals the storage space 14a in a closed state.

The home appliance device 10a comprises a protrusion unit 22a arranged next to the sealed door section 18a outside the storage space 14a. The protrusion unit 22a protrudes from the door 16a towards the main body 12a. The door 16a features a non-sealed door section 68a arranged next to the sealed door section 18a. The non-sealed door section 68a is arranged below the sealed door section 18a with respect to the height direction 66a. The protrusion unit 22a is connected to the door 16a. The protrusion unit 22a is connected to the non-sealed door section 68a. It is conceivable that a non-sealed door section and/or a protrusion unit is arranged above a sealed door section. Furthermore, it is conceivable that a protrusion unit is connected to a main body.

The protrusion unit 22a features a smaller horizontal extent 24a than the sealed door section 18a, in particular parallel to a horizontal direction 72a of the door 16a. The horizontal direction 72a of the door 16a is oriented perpendicularly to the height direction 66a and parallel to a main extension plane of the door 16a.

The horizontal extent 24a of the protrusion unit 22a is smaller than 20% of a horizontal extent 70a of the sealed door section 18a. The horizontal extent 24a of the protrusion unit 22a is significantly smaller than the horizontal extent 70a of the sealed door section 18a.

The home appliance device 10a comprises a door opening assisting unit 26a which has an opening element 28a. The opening element 28a is implemented as a push rod. The opening unit 26a is configured for partly opening the door 16a upon a user request for a door opening.

FIG. 4 shows a portion of the home appliance device 10a, including the door opening assisting unit 26a, in a schematic lateral sectional view. Upon a user request of a door opening, the opening element 28a is moved towards the door 16a in order to partly push the door 16a open.

The protrusion unit 22a features a contact element 30a for the opening element 28a. The contact element 30a is connected to the door 16a. The contact element 30a is provided for transmitting an opening force onto the door 16a. The opening element 28a is provided for being pushed against the contact element 30a. The contact element 30a is arranged opposite the opening element 28a.

The contact element 30a features a contact surface 32a for the opening element 28a, which contact surface 32a is aligned parallel to the main extension plane of the door 16a. The contact element 30a protrudes from the door 16a towards the main body 12a. The opening element 28a therefore has to be moved only over a short distance for opening the door 16a.

FIG. 4 shows a portion of the home appliance device 10a in a schematic sectional top view. The protrusion unit 22a comprises an air separator 40a which separates two adjacent air spaces 42a, 44a, namely a first air space 42a and a second air space 44a, which are located outside the storage space 14a and are arranged between the door 16a and the main body 12a.

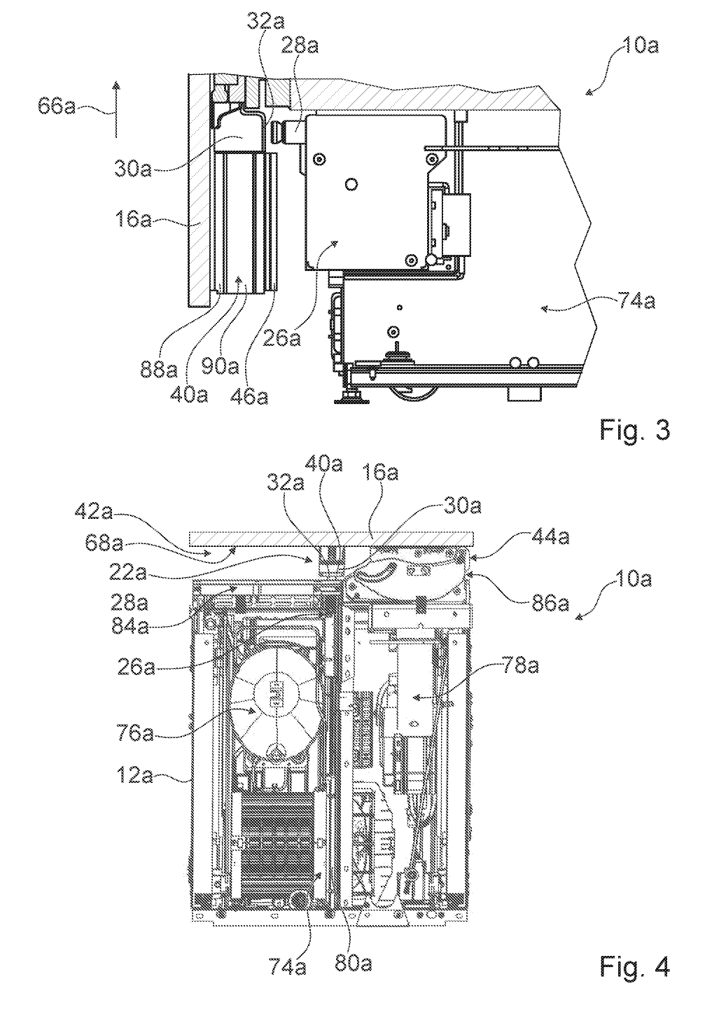

The home appliance device 10a comprises a machine compartment 74a. The machine compartment 74a is arranged below the storage space 14a with respect to the height direction 66a. The machine compartment 74a features a first sub-compartment 76a and a second sub-compartment 78a. The first sub-compartment 76a is arranged behind the first air space 42a. The second sub-compartment 78a is arranged behind the second air space 44a. The first sub-compartment 76a and the second sub-compartment 78a are separated from each other by a divisional wall 80a. The first sub-compartment 76a is connected to the first air space 42a and the second sub-compartment 78a is connected to the second air space 44a via at least one ventilation grille 82a. The ventilation grille 82a is not shown in FIG. 3 for reasons of clarity. The first sub-compartment 76a comprises a fresh-air entrance 84a, which is connected to the first air space 42a. The second sub-compartment 78a comprises a heated-air exit 86a, which is connected to the second air space 44a. The first air space 42a and the second air space 44a are delimited by the sealed door section 18a on a top side. The first air space 42a and the second air space 44a are open towards an outside, in particular towards a bottom side of the main body 12a.

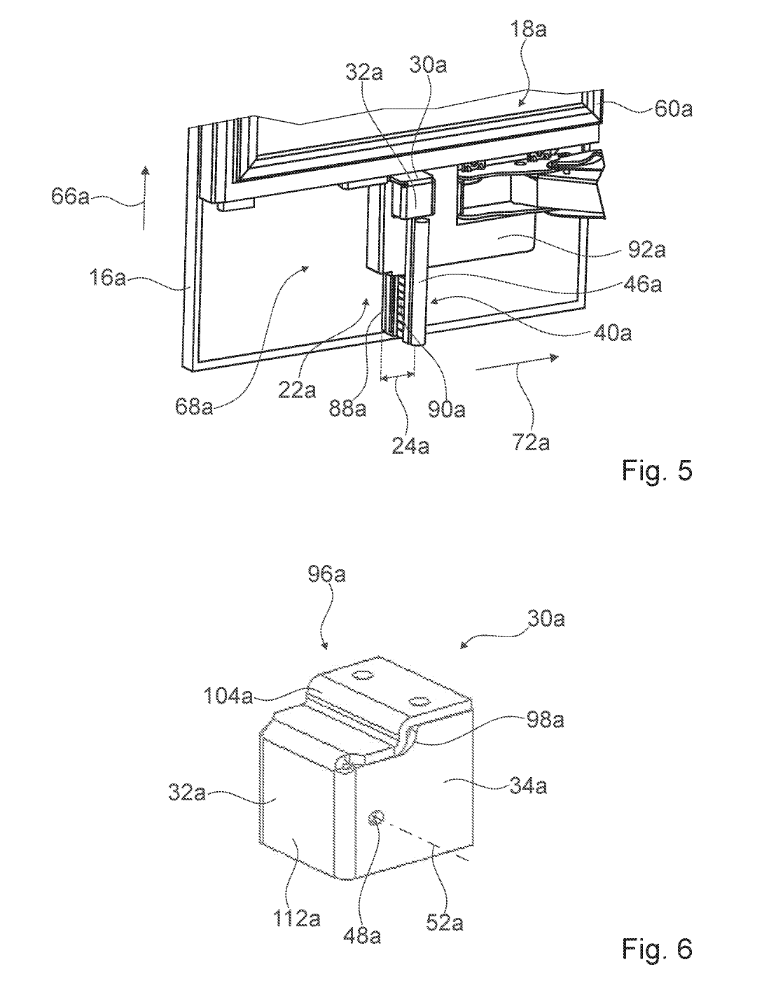

FIG. 5 shows a portion of the door 16a of the home appliance device 10a, including the protrusion unit 22a, in a perspective view. The air separator 40a is connected to the door 16a. The air separator 40a is connected to the non-sealed door section 68a. In a closed state of the door 16a, the air separator 40a is in contact with the door 16a and with the main body 12a. The air separator 40a is plate-shaped. A main extension plane of the air separator 40a is oriented perpendicularly to the main extension plane of the door 16a and parallel to the height direction 66a. A main extension direction of the air separator 40a is oriented parallel to the height direction 66a. The air separator 40a is arranged next to the contact element 30a, in particular below the contact element 30a. The air separator 40a is in contact with the contact element 30a. In the shown case the air separator 40a is made of plastic.

The air separator 40a features a sealing element 46a that contacts the main body 12a, in particular in the closed state of the door 16a. The sealing element 46a is implemented as a sealing lip. A main extension direction of the sealing element 46a is oriented parallel to the height direction 66a. The air separator 40a features an additional sealing element 88a that contacts the door 16a, in particular the non-sealed door section 68a. Furthermore, the air separator 40a features a support element 90a. The sealing element 46a is connected to the support element 90a. The additional sealing element 88a is connected to the support element 90a. The additional sealing element 88a is significantly shorter than the sealing element 46a. The additional sealing element 88a features a length which is smaller than 50% of a length of the sealing element 46a. The sealing element 46a is made of rubber. The additional sealing element 88a is made of rubber.

The air separator 40a is connected to the contact element 30a. The air separator 40a is partly inserted in the contact element 30a. The contact element 30a covers the air separator 40a on a top end. The support element 90a is partly inserted in the contact element 30a. The contact element 30a is open towards a bottom side of the main body 12a. The protrusion unit 22a features a cover element 92a that covers a portion of the non-sealed door section 68a. The additional sealing element 88a contacts the cover element 92a.

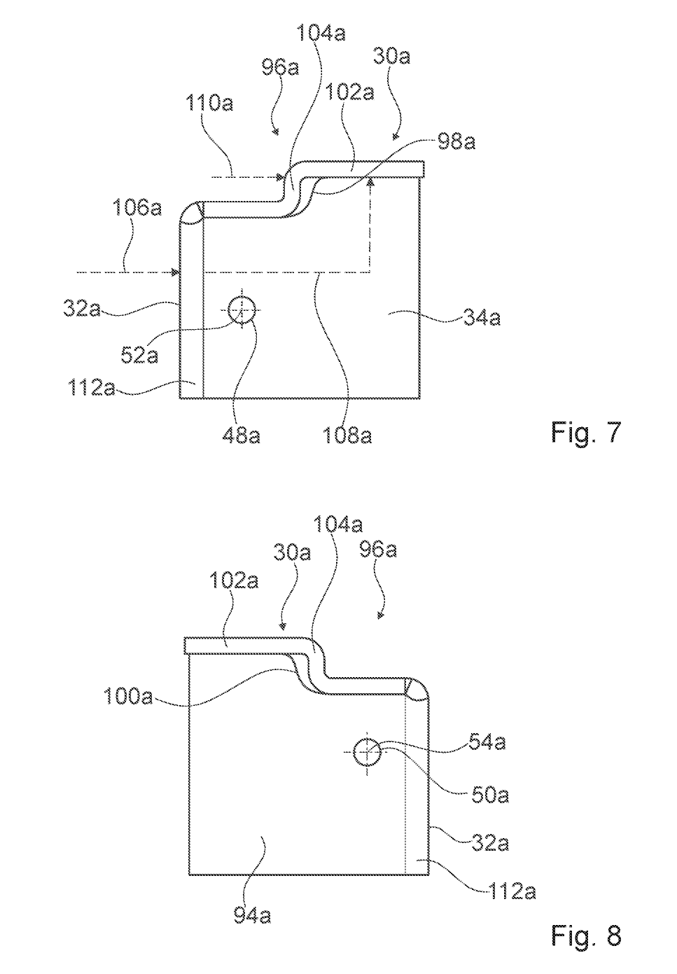

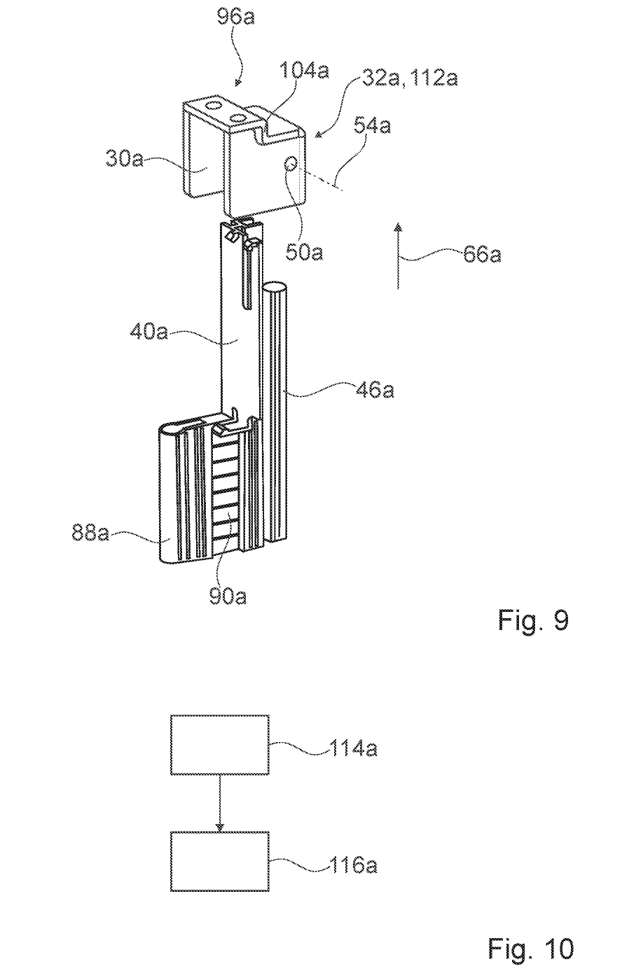

The contact element 30a and the air separator 40a are further shown in FIGS. 6 to 9. FIG. 6 shows the contact element 30a, in a perspective view. FIG. 7 shows the contact element 30a, in a schematic lateral view from a first lateral side. FIG. 8 shows the contact element 30a in an additional schematic lateral view from a second lateral side that is opposite the first lateral side. FIG. 9 shows the protrusion unit 22a, in a schematic exploded view.

The contact element 30a is implemented as a bent sheet metal piece. The contact element 30a has a closed-corner design. The contact element 30a features a contact element side wall 34a with a step-shaped contour 98a. The contact element side wall 34a is a lateral side wall. The step-shaped contour 98a is arranged on a top side 96a of the contact element 30a. The contact element 30a features a second contact element side wall 94a with a step-shaped contour 100a. The second contact element side wall 94a is a lateral side wall. The contact element 30a features a contact element top wall 102a which follows the step-shaped contour 98a. The contact element top wall 102a forms a step 104a. The contact element 30a is step-shaped. The contact element 30a is configured for transmitting a force 106a exerted onto the contact surface 32a along at least two different force transmission paths 108a, 110a.

The contact element top wall 102a is connected to the door 16a. In the case shown the contact element 30a is connected to the door 16a via screws.

The contact element 30a comprises a contact element front wall 112a which comprises the contact surface 32a. The contact element side wall 34a, the second contact element side wall 94a and the contact element top wall 102a are connected to the contact element front wall 112a. The contact element 30a is made of one piece.

The contact element 30a features two mounting holes 48a, 50a for the air separator 40a which have different hole axes 52a, 54a. The air separator 40a is connected to the contact element 30a via screws that are not shown in the figures and are arranged in the mounting holes 48a, 50a.

FIG. 10 shows a schematic flow chart of a method for assembling the home appliance device 10a. In a first assembly step 114a the contact element 30a is attached to the door 16a. In a second assembly step 116a the air separator 40a is attached to the contact element 30a. In the second assembly step 116a the air separator 40a is slid into the contact element 30a from below. Subsequently, the air separator 40a is fixed to the contact element 30a by means of screws which are screwed through the mounting holes 48a, 50a into the air separator 40a.

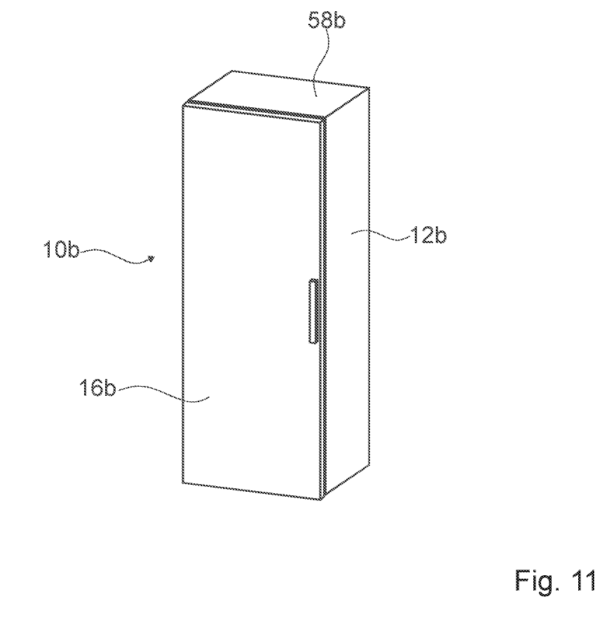

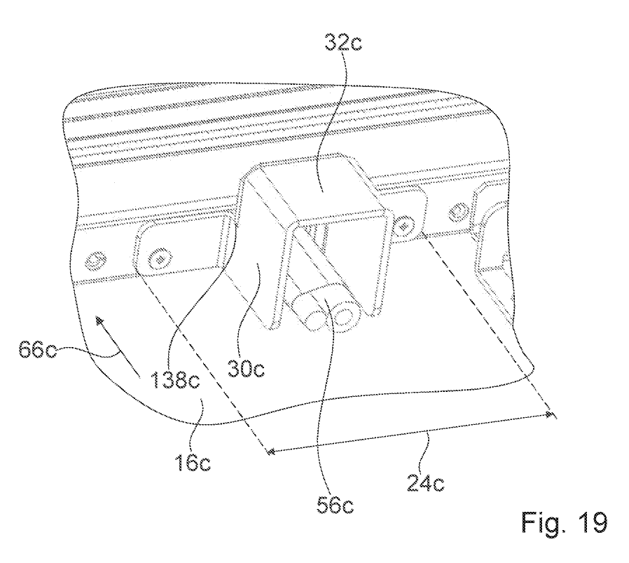

FIGS. 11 to 19 show further exemplary embodiments of the invention. The following description is substantially limited to the differences between the exemplary embodiments, wherein regarding structural elements, features and functions that remain the same the description of the other exemplary embodiments, in particular the exemplary embodiment of FIGS. 1 to 10, may be referred to. For distinguishing the exemplary embodiments, the letter a of the reference numerals in the exemplary embodiment of FIGS. 1 to 10 has been substituted by the letters b and c in the reference numerals of the exemplary embodiments of FIGS. 11 to 19. Regarding structural elements having the same denomination, in particular regarding structural elements having the same reference numerals, principally the drawing and/or the description of the other exemplary embodiments, in particular of the exemplary embodiment of FIGS. 1 to 10, may be referred to.

FIG. 11 shows an alternative home appliance 58b comprising an alternative home appliance device 10b, in a perspective view. The home appliance device 10b comprises a main body 12b and a door 16b which is mounted to the main body 12b.

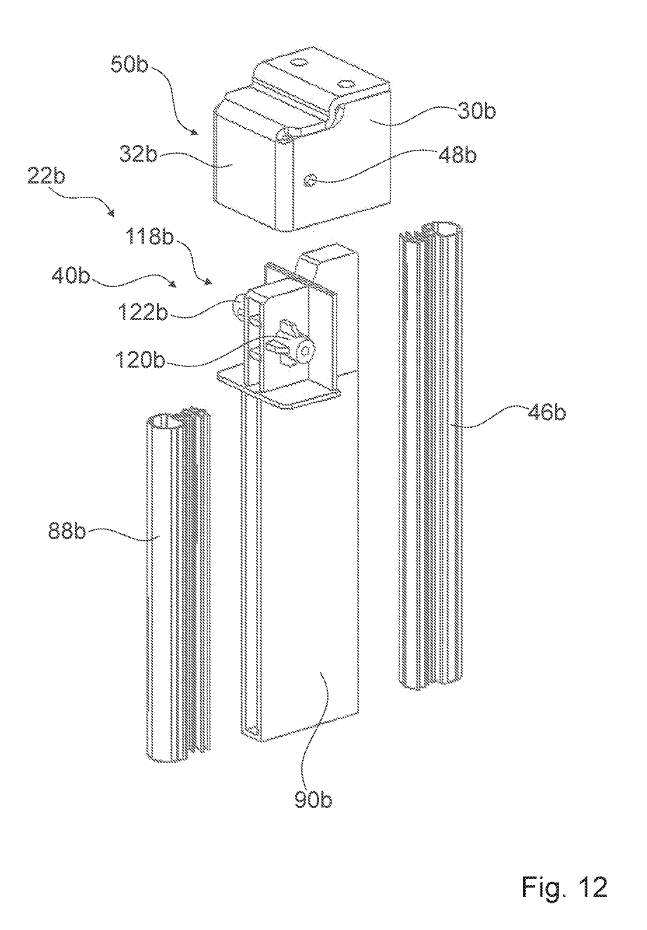

FIG. 12 shows a protrusion unit 22b of the alternative home appliance device 10b, in a schematic exploded view. The protrusion unit 22b is implemented analogously to the protrusion unit 22a of the exemplary embodiment of FIGS. 1 to 10.

The protrusion unit 22b comprises a contact element 30b and an air separator 40b. The air separator 40b comprises a support element 90b, a sealing element 46b and an additional sealing element 88b. In an assembled state the sealing element 46b contacts the main body 12b. The additional sealing element 88b is shorter than the sealing element 46b by approximately 25%.

The contact element 30b comprises a contact surface 32b for an opening element of a door opening assisting unit of the alternative home appliance device. The contact element 30b is implemented as a bent sheet metal piece. In the assembled state the air separator 40b is partly inserted in the contact element 30b.

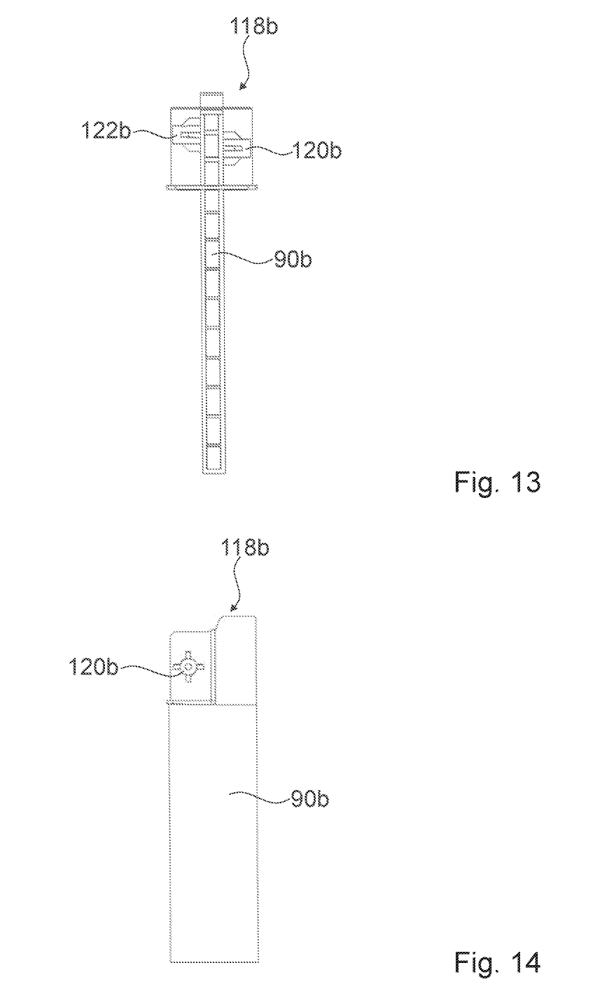

FIG. 13 shows the support element 90b of the air separator 40b, in a schematic front view. FIG. 14 shows the support element 90b, in a schematic lateral view. The support element 90b features a head portion 118b. In an assembled state, the head portion 118b is arranged within the contact element 30b. The head portion 118b features receiving elements 120b, 122b for fastening elements. The contact element 30b features mounting holes 48b, 50b for the air separator 40b. The air separator 40b is connected to the contact element 30b by means of fastening elements which are arranged in the mounting holes 48b, 50b and are connected to the receiving elements 120b, 122b. The receiving elements 120b, 122b are arranged in a staggered manner.

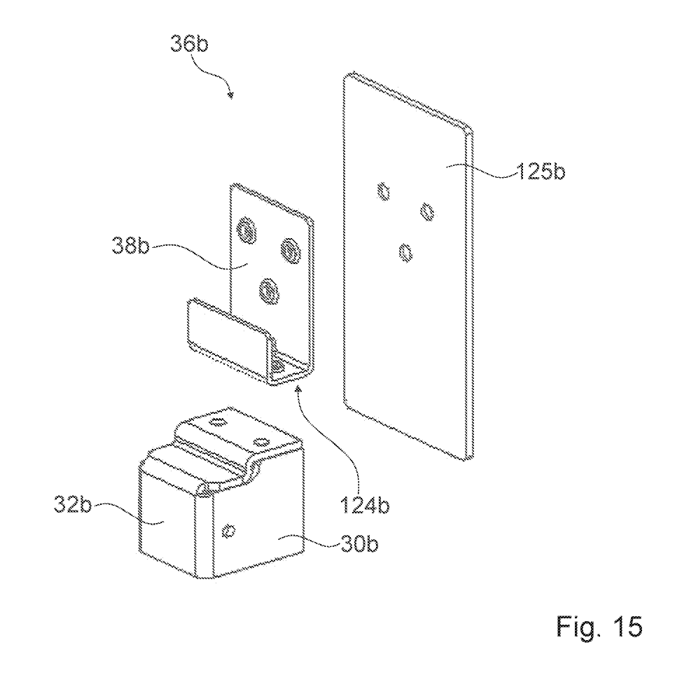

FIG. 15 shows the contact element 30b and a fixing unit 36b of the alternative home appliance device 10b, in a perspective view. The fixing unit 36b comprises a fixing element 38b. In the assembled state the contact element 30b is fixed to the fixing element 38b. Furthermore, in the assembled state the fixing element 38b is arranged inside a foamed gap space of the door 16b. The contact element 30b is screwed to the fixing element 38b from a bottom side 124b of the fixing element 38b. The fixing element 38b is made of metal.

In the case shown the fixing unit 36b comprises a support element 125b which the fixing element 38b is connected to. The fixing element 38b is screwed to the support element 125b. The support element 125b is a metal plate. The support element 125b is arranged outside the foamed gap space of the door 16b. The support element 125b is arranged within the door 16b. The support element 125b is arranged on a side of the foamed gap space of the door 16b which faces away from the main body 12b.

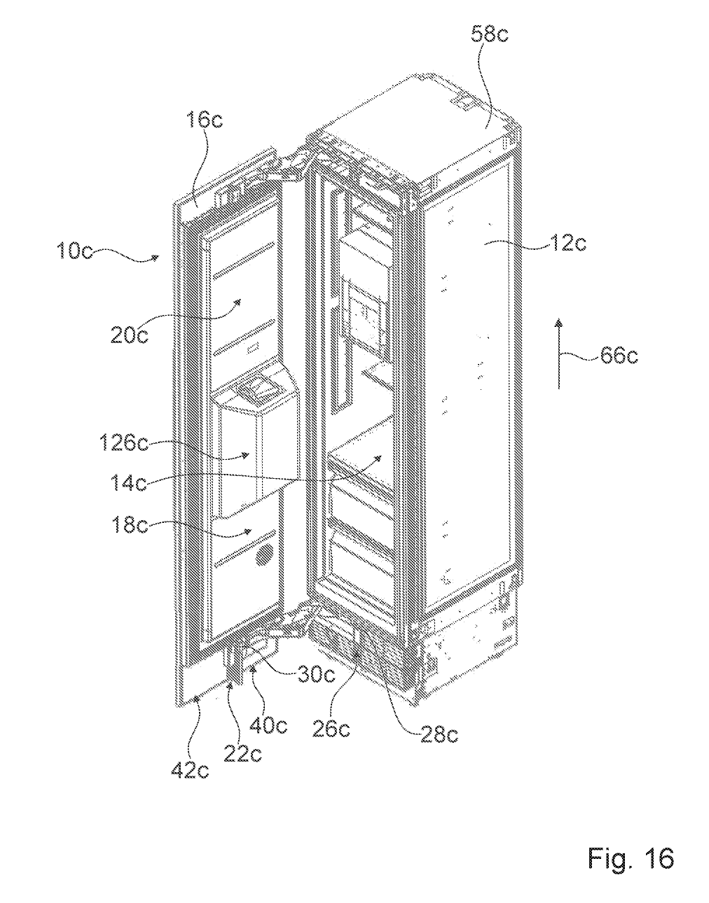

FIG. 16 shows a further alternative home appliance 58c, in a perspective view. The further alternative home appliance 58c comprises a further alternative home appliance device 10c. The further alternative home appliance 58c is implemented as a refrigerator. The further alternative home appliance device 10c is implemented as a home chiller appliance device. The further alternative home appliance device 10c comprises a main body 12c that defines a storage space 14c. The further alternative home appliance device 10c comprises a door 16c mounted to the main body 12c, which door 16c features a sealed door section 18c that forms a portion of a front wall 20c, in particular the entire front wall 20c, of the storage space 14c. The further alternative home appliance device 10c comprises a protrusion unit 22c which is arranged next to the sealed door section 18c outside the storage space 14c and protrudes from the door 16c towards the main body 12c.

The protrusion unit 22c features a smaller horizontal extent 24c than the sealed door section 18c.

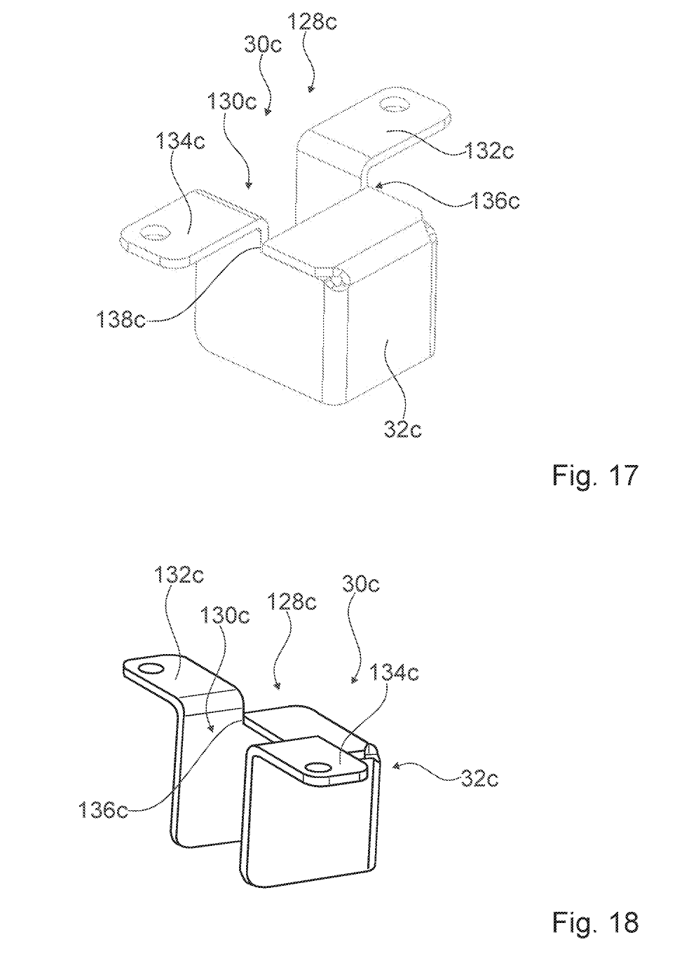

The further alternative home appliance device 10c comprises a door opening assisting unit 26c which has an opening element 28c. The protrusion unit 22c features a contact element 30c for the opening element 28c. The contact element 30c is shown in two different perspective views in FIGS. 17 and 18. The contact element 30c features a contact surface 32c for the opening element 28c, which contact surface 32c is aligned parallel to a main extension plane of the door 16c.

The protrusion unit 22c features an air separator 40c which separates two adjacent air spaces 42c, 44c located outside the storage space 14c and arranged between the door 16c and the main body 12c.

The home appliance device 10c comprises an ice water dispenser unit 126c. The ice water dispenser unit 126c is connected to the door 16c. The ice water dispenser unit 126c is arranged inside the storage space 14c in a closed state of the door 16c. It is also conceivable that an ice water dispenser unit is arranged outside a storage space.

FIG. 18 shows a portion of the further alternative home appliance device 10c, in a perspective view. The ice water dispenser unit 126c comprises a liquid line 5c. The liquid line 56c is a water supply line. The liquid line 56c runs through the protrusion unit 22c. The liquid line 56c runs through the contact element 30c. The liquid line 56c runs through the protrusion unit 22c in a direction parallel to a height direction 66c of the main body 12c. The contact element 30c is open towards a top side 128c of the contact element 30c in order to provide an opening 130c for the liquid line 56c. The contact element 30c comprises a connection element 132c for fixing to the door 16c. The connection element 132c is wing-shaped. The connection element 132c is bent outward with respect to the opening 130c. The contact element 30c comprises an additional connection element 134c for fixing to the door 16c. The additional connection element 134c is implemented mirror-symmetrically with respect to the connection element 132c. The connection element 132c and the additional connection element 134c are screwed to the door 16c. The connection element 132c implements a force transmission point 136c towards a contact element top wall 102c and a contact element front wall 112c, which contact element front wall 112c features the contact surface 32c. An opening force is transmitted from the contact surface 32c, via the force transmission point 136c, towards the connection element 132c and to the door 16c. Analogously, the additional connection element 134c implements an additional force transmission point 138c.

The following is a summary list of reference numerals and the corresponding structure used in the above description of the invention:

10 home appliance device

12 main body

14 storage space

16 door

18 sealed door section

20 front wall

22 protrusion unit

24 horizontal extent

26 door opening assisting unit

28 opening element

30 contact element

32 contact surface

34 contact element side wall

36 fixing unit

38 fixing element

40 air separator

42 air space

44 air space

46 sealing element

48 mounting hole

50 mounting hole

52 hole axis

54 hole axis

56 liquid line

58 home appliance

60 sealing lip

62 outer liner

64 inner liner

66 height direction

68 non-sealed door section

70 horizontal extent

72 horizontal direction

74 machine compartment

76 sub-compartment

78 sub-compartment

80 wall

82 ventilation grille

84 fresh-air entrance

86 heated-air exit

88 sealing element

90 support element

92 cover element

94 contact element side wall

96 top side

98 contour

100 contour

102 contact element top wall

104 step

106 force

108 path

110 path

112 contact element front wall

114 assembly step

116 assembly step

118 head portion

120 receiving element

122 receiving element

124 bottom side

125 support element

126 ice water dispenser unit

128 top side

130 opening

132 connection element

134 connection element

136 force transmission point

138 force transmission point

1. A home appliance device, in particular a home chiller appliance device, comprising: at least one main body defining at least one storage space; at least one door mounted to the main body and featuring at least one sealed door section that forms at least a portion of a front wall of the storage space; and at least one protrusion unit arranged next to the sealed door section outside the storage space and protruding from the door towards the main body.

2. The home appliance device according to claim 1, the protrusion unit featuring a smaller horizontal extent than the sealed door section.

3. The home appliance device according to claim 1, comprising a door opening assisting unit which has at least one opening element, wherein the protrusion unit features at least one contact element for the opening element.

4. The home appliance device according to claim 3, the contact element featuring at least one contact surface for the opening element, which contact surface is aligned at least substantially parallel to a main extension plane of the door.

5. The home appliance device according to claim 3, the contact element being implemented as a bent sheet metal piece.

6. The home appliance device according to claim 3, the contact element featuring at least one contact element side wall with a step-shaped contour.

7. The home appliance device according to claim 3, comprising a fixing unit featuring at least one fixing element, the contact element being fixed to the fixing element, and the fixing element being arranged inside a foamed gap space of the door.

8. The home appliance device according to claim 1, the protrusion unit featuring at least one air separator which separates two adjacent air spaces located outside the storage space and arranged between the door and the main body.

9. The home appliance device according to claim 8, the air separator featuring at least one sealing element that contacts the main body.

10. The home appliance device according to claims 3, the air separator being connected to the contact element.

11. The home appliance device according to claim 10, the air separator being partly inserted in the contact element.

12. The home appliance device according to claim 10, the contact element featuring at least two mounting holes for the air separator which have different hole axes.

13. The home appliance device according to claim 1, comprising at least one liquid line which runs through the protrusion unit.

14. A home appliance, in particular a home chiller appliance, comprising at least one home appliance device according to claim 1.

15. A method for assembling a home appliance device, in particular a home chiller appliance device, comprising: at least one main body defining at least one storage space; at least one door mounted to the main body and featuring at least one sealed door section that forms at least a part of a front wall of the storage space; at least one door opening assisting unit having at least one opening element; and at least one protrusion unit arranged next to the sealed door section outside the storage space, which protrudes from the door towards the main body and which features at least one contact element for the opening element and at least one air separator separating two adjacent air spaces located outside the storage space and arranged between the door and the main body; wherein the air separator is attached to the contact element.

16. The method according to claim 15 configured for assembling a home chiller appliance device according to claim 1.
